(19) United States
(12) Patent Application Publication
(10) Pub. No.: US 2017/0155737 A1
(43) Pub. Date: Jun. 1, 2017

(54) CONTEXT-AWARE INFORMATION DISCOVERY

(71) Applicant: Let's Maybe, Inc., Palo Alto, CA (US)

(72) Inventors: Jan Jannink, Menlo Park, CA (US); Leonardo Hochberg, Palo Alto, CA (US)

(21) Appl. No.: 14/955,942

(22) Filed: Dec. 1, 2015

(51) Int. Cl. H04L 29/08; H04W 4/00

(52) U.S. Cl. CPC H04L 67/327; H04L 67/306; H04L 67/18; H04W 4/005

(57) ABSTRACT

In an embodiment, contextual data is gathered via sensors at a client device. This contextual data is transferred to servers associated with a system to inform scoring of available content to present to a user. Available content can include content curated by the user, content curated by other users associated with the user, and other external content. The system generates lists of relevant content based on the scoring and presents the lists of contextually relevant content to the user via the client device. Data associated with user interaction with items in the list is returned to the servers associated with the system and can be used to build a user pattern profile associated with the user and/or to update scoring of available content items.

### TECHNICAL FIELD

The disclosed innovations generally relate to search engine and content recommendation technology, specifically to technology that incorporates contextual information gathered at a client device to provide contextually relevant content to users.

### BRIEF DESCRIPTION OF THE DRAWINGS

FIG. 1 is an architecture diagram of an example system suitable for implementing the innovations disclosed herein;

FIG. 2 is a flow chart describing an example process for providing context-aware information discovery;

FIG. 3 shows example user interactions with an interface presented at a client device to keep and demote content in a sorted list;

FIG. 4 shows example user interactions with an interface presented at a client device to filter presented content or curate/create new content;

FIG. 5 shows example interface layouts for several representative views presented at a client device;

FIG. 6 is a diagram illustrating a machine in the example form of a computer system within which a set of instructions, for causing the machine to perform any one or more of the methodologies discussed herein, can be executed.

### DETAILED DESCRIPTION

From the foregoing, it will be appreciated that specific embodiments of the invention have been described herein for purposes of illustration, but that various modifications may be made without deviating from the scope of the invention. Accordingly, the invention is not limited except as by the appended claims.

### Overview

Search engines search available data and return ranked results based on provided search criteria. The present disclosure teaches innovations for ranking that may be dependent on current physical context of a user and/or device associated with the user as well as on a user's current knowledge. In some embodiments ranked results can also depend on the context/knowledge of other users associated with a given user.

In an embodiment of the present innovation, a system for context-aware information discovery combines previously curated content from a user (or other users associated with the user) as well as new content from external sources into information sets which can then be ranked at any point in time using contextual criteria. Contextual criteria can include, but is not limited to location, movement, time, weather, fitness, personal relevance (e.g. similarity to previous curated items, related users curated items, and similarity to those with similar interest profiles in addition to traditional search engine ranking technology), and other external signals.

This results in recommendations and reminders that are more relevant to individual users given particular context. Importantly, this approach can also allow users to use a simple combined visual interface that is suitable for both previously unseen content as well as for curated content that the user or other users have previously seen, approved, or created themselves.

### Example System Architecture

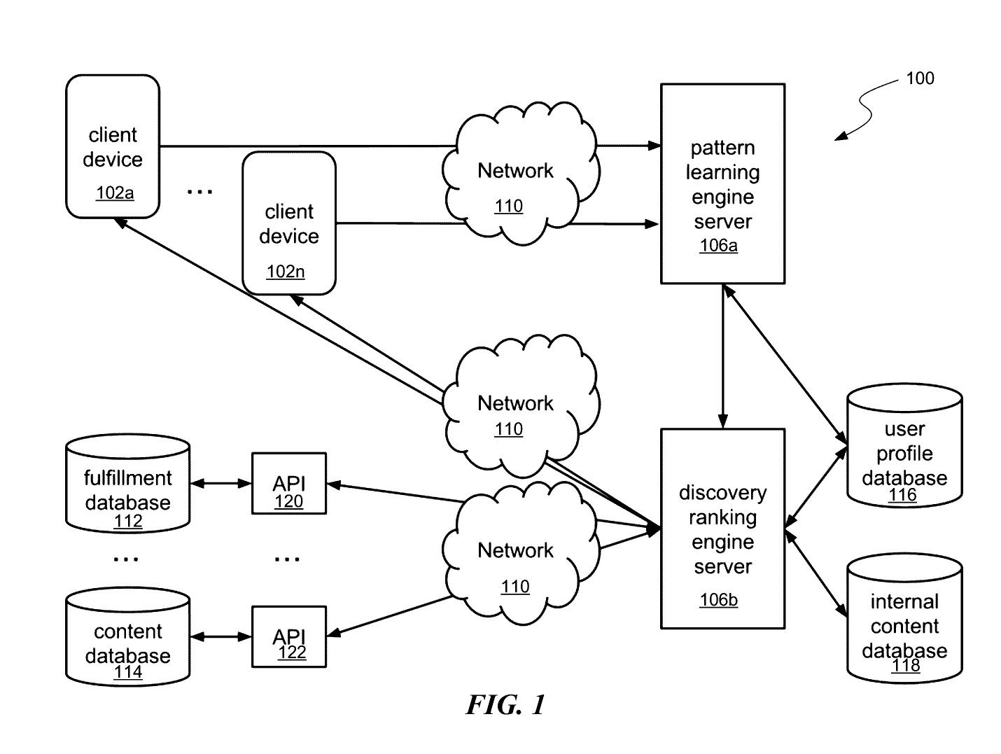

FIG. 1 is an architecture diagram of an example system 100 suitable for implementing the innovations disclosed herein.

A system 100, as described with respect to FIG. 1, can include the following features:
network connected client mobile devices that track location, time, activity, companions, and other contextual data through sensors on the device, allow users to generate curated information to send to servers, and receive sets of information over the network
network connected servers that collect user curated content and sensor data tracked by mobile devices and deliver sets of information to those mobile devices, and connect via APIs to various information sources to generate information sets, and fulfill user responses to those information sets
network infrastructure that transmits information sets from servers to mobile devices, user driven responses to those information sets back to the servers as well as sensor data from mobile devices, and support the API connections between servers and other information sources
optionally, network connected client computing devices users can substitute for their mobile devices when the users prefer higher capacity devices to interact with the system
user curated information that is added to the server information management system through the user mobile devices and user computing devices
location, speed, orientation and other sensor data from user devices that are used to establish contextual input to the ranking of information items destined for the user
user responses to received information sets, which enable refined understanding of user preferences for future received information sets
API accessible information sources or databases, such as current and classic movies, TV shows, books, music; local or global eateries, bars, cafes; ongoing or time limited ticketed sports events, concerts, museum exhibits, parks, etc.
optionally, API accessible fulfillment resources, such as book sellers, video streaming services, restaurant reservations, concert tickets, sports event ticketing, etc. enabling monetization of the system through affiliate fees
database management of user profile information including GPS and sensor data, social circle, curated content, responses to previously viewed content generated from APIs
discovery ranking engine that combines user profile information with API source information to create information sets to present to the user
pattern learning engine that receives sensor data, curated user content, responses to novel presented data and appends these to the user profile, and forwards requests to fulfillment APIs to act on the user's chosen information, thus monetizing them.
information sets or lists containing one or more items ranked by the ranking engine. Lists contain user curated content or items retrieved from API information sources
items may also include metadata such as other interested users, their recommendations, schedules, prices, purchasing information, etc.
user patterns consisting of but not limited to the users created content and metadata, their responses to novel recommended items, time series representations of user app context, location, speed, orientation, temperature, etc. based on the received app sensor and GPS data.

As shown in FIG. 1, example system 100 includes one or more client devices 102a-n in communication with servers 106a-b via a network 110. Servers 106a-b are in communication with databases 112, 114, 116, 118, in some embodiments via an API 120, 122.

According to the example system 100, client devices 102a-n can track contextual data (e.g. location, orientation, time, activity, companions, and other contextual data) using sensors associated with the device 102a-n. Users can generate curated information and transmit to and receive data from servers 106a-b a client device 102a-n connected to network 110.

The client devices 102a-n can be any system and/or device, and/or any combination of devices/systems that are able to establish a connection with another device, a server and/or other systems. Client devices 102a-n each typically include a display and/or other output functionalities to present information and data exchanged between among the devices 102A-N and the host server 100. The client devices 102a-n can be provided with user interfaces (not shown) for accessing data generated or supplied by servers 106a-b. Data generated or supplied by servers 106a-b can be viewed in, for example, a webpage interface that is hosted by a server (e.g. servers 106a-b). In alternative embodiments, a software application (e.g., a conventional desktop software application or a mobile application (“app”)) can run on a client devices 102a-n that provides the same or similar interface for the users to manage database workload analysis and data transformation jobs. In some embodiments, the functionalities of the platform can be provided from servers 106a-b to the users through third-party applications (e.g., through the use of an application programming interface (API)).

Examples of the client devices 102a-n can include computing devices such as mobile or portable devices or non-portable devices. Non-portable devices can include a desktop computer, a computer server or cluster. Portable devices can including a laptop computer, a mobile phone, a smart phone, a personal digital assistant (PDA), a handheld tablet computer. Typical input mechanism on client devices 102A-N can include a touch screen display (including a single-touch (e.g., resistive) type or a multi-touch (e.g., capacitive) type), gesture control sensors, a physical keypad, a mouse, motion detectors (e.g., accelerometer), light sensors, temperature sensor, proximity sensor, device orientation detector (e.g., compass, gyroscope, or GPS), and so forth.

According to some embodiments, servers 106a-b can collect user curated content and contextual data tracked by client devices 102a-n, deliver sets of information to those devices 102a-102n, and connect via APIs 120, 122 to various information sources 112, 114 to generate information sets, and fulfill user responses to those information sets. Servers 106a-b can also store data (e.g. information sets containing content and or user information) at databases or repositories 116, 118. Further, user driven response to received information sets can be transmitted from client devices 102a-n to servers 106a-b via network 110. User responses to received information sets, can enable refined understanding of user preferences for future received information sets.

Specifically, system 100 may include a server 106a implementing a pattern learning engine that receives contextual data (e.g. sensor data), curated user content, user responses to newly presented data and appends these to a user profile (e.g as stored at user profile database 116), and forwards requests to fulfillment APIs to act on the user's chosen information, thus monetizing them. In some embodiments, a pattern learning engine can identify user patterns including, but not limited to, patterns in the user's created content and metadata, responses by the users to recommended items, and time series representations of user context (e.g., location, speed, orientation, temperature, etc.

System 100 may also include a server 106b implementing a discovery ranking engine combines user profile information (e.g. from user profile database 116) with API source information (e.g. from content database 114) to create information sets to present to the user via client device 102a-n. A discovery ranking engine may generate information lists or sets including one or more items ranked by the ranking engine. Information lists or sets can include user curated content or items retrieved from external information sources. Items may also include metadata such as other interested users, their recommendations, schedules, prices, purchasing information, etc.

Information sources may include API accessible content databases or repositories 114 that store content data including but not limited to movies, TV shows, books, music, etc. or content data associated with local or global eateries, bars, cafes, ongoing or time limited ticketed sports events, concerts, museum exhibits, parks, etc. Information source may also include API accessible fulfillment databases or repositories 112 that store data associated with fulfillment resources such as book sellers, video streaming services, restaurant reservation services, concert tickets, event ticketing, etc., enabling monetization of the system through affiliate fees.

Databases/repositories 112, 114, 116, 118 can be managed by a database management system (DBMS) including, for example, MySQL, SQL Server, Oracle, and so forth. In variations, Databases/repositories 112, 114, 116, 118 can be implemented and managed by a distributed database management system, an object-oriented database management system (OODBMS), an object-relational database management system (ORDBMS), a file system, a NoSQL or other non-relational database system, and/or any other suitable database management package. Databases/repositories 116, 118 can may be physically connected to the servers 106a-b or can be remotely accessible through a network (e.g. network 110).

The network 110 can be any collection of distinct networks operating wholly or partially in conjunction to provide connectivity to the client devices 102a-n, servers 106a-b, and any other suitable components in FIG. 1, which may appear as one or more networks to the serviced systems and devices. In one embodiment, communications to and from the client devices 102a-n can be achieved by an open network, such as the Internet, or a private network, such as an intranet and/or the extranet. For example, the Internet can provide file transfer, remote log in, email, news, RSS, cloud-based services, instant messaging, visual voicemail, push mail, VoIP, and other services through any known or convenient protocol, such as, but is not limited to, the TCP/IP protocol, Open System Interconnection (OSI) protocols, and so forth. In one embodiment, communications can be achieved by a secure communications protocol, such as secure sockets layer (SSL), or transport layer security (TLS).

The client devices 102a-n, the servers 106a-b, databases/repositories 112, 114, 116, 118 can be communicatively coupled to each other through the network 110 and/or multiple networks. In some embodiments, the devices 102a-n and the servers 106a-b may be directly connected to one another.

In addition, communications can be achieved via one or more wired or wireless networks including, for example, a Local Area Network (LAN), Wireless Local Area Network (WLAN), a Wide Area Network (WAN). These networks can be enabled with communications technologies such as Global System for Mobile Communications (GSM), Personal Communications Service (PCS), Bluetooth, Wi-Fi, 2G, 3G, LTE Advanced, WiMax, etc., and with messaging protocols such as Ethernet, SMS, MMS, real time messaging protocol (RTMP), IRC, or any other suitable data networks or messaging protocols.

System 100 described in FIG. 1 can alternatively be fully implemented in a single computing device, for example using virtual machines to implement each of the database, server and client device functions, or on multiple devices comprising one or more each of the client, server and network systems, with sensor data collection, user input and response software, server data management, API handling, ranking and response engines running on them.

### Example System Operation

In use, a system 100 as described above can create a user pattern profile for each user. For example, in an embodiment a user pattern engine at server 106a can create a user pattern profile based on the metadata collected from user interactions with presented content together with lists from multiple sources, including the user's curated content list, the related users' lists and lists from external content sources. User pattern profiles may be created using machine learning techniques such as decision trees and neural networks to identify a user's most salient activity patterns. This user pattern profile may be stored at database/repository 116 and may be utilized by a ranking engine at server 106b to blend the user's own content with other content sources in a way that best matches the user's preferences.

In normal operation, system 100 can rely on an existing user pattern profile for a user of a client device 102a-n. As previously described, this user pattern profile can be stored at a database or repository 116 and can be accessed by the pattern learning engine and discovery ranking engines at servers 106a-b. However, when a user initially accesses system 100, no user pattern profile will exist for that user. Using the same system architecture as described in FIG. 1, system 100 can operate in an initialization mode to present relevant content to the user without specific knowledge of the user's preferences and patterns. For example, in an embodiment, system 100 receives contextual data (e.g. location data, time data, device info, etc.) from a client device associated with the user. Based on this received contextual data, system 100 presents a sorted list of available content (e.g. external content) that is contextually relevant and tailored to induce user interaction, from which the system can learn about the user's patterns and preferences. For example, to learn about the user's musical tastes, system 100 can present content items (e.g. a graphical flyer, a music video, a link to a third-party ticketing service) associated with a musical performance by a popular artist occurring in close geographic and temporal proximity with the user. As described herein, the system allows the user to keep or demote a content item in the presented list of content items, thereby inducing user interaction with the list of items. If the user keeps or demotes a content item associated with the musical performance by the popular artist, the system can infer preferences or patterns in the user's behavior. For example, if the user demotes a content item, the system can infer that the user is either not interested in the artist, not interested in the particular genre of music in general, or busy currently and not available to attend the performance. The system can then present additional content items based on the inference to further learn about the user's preferences and patterns. For example, the system can follow up by presenting a content item associated with a performance by the same artist at a later date or a performance by a different artist. This process can continue to build a user pattern profile, as previously discussed.

The ranking engine (e.g. at server 106b) produces a score for each available item based on the user profile pattern and effectively creates a sorted list of items. This ranking may use a neural network defined during the creation and maintenance of the user profile pattern. By measuring the familiarity and popularity of the people, places and things the user interacts with, the system derives a measure of how the user will react to novel content, and finds which contexts the user is most accepting of novel content.

The pattern engine (e.g. at server 106a) continuously collects user data from the application (e.g. user interaction data and contextual data) to distinguish patterns in user activity/preferences. For example, based on received contextual data (e.g. location data) from client device 102a-n, the pattern engine can identify locations that the user frequents, locations that are popular among other users (both currently and historically), activities associated with the identified locations, and user interactions (e.g., with other users) associated with identified locations. Further, the pattern engine can identify content associated with a user's activity pattern that may be relevant to that user. For example, based on the locations the user frequents and the other users the user interacts with at those locations, a pattern can emerge that provides insight into the users content preferences.

The user pattern profile that emerges from this includes a labelling of locations, activities, people and media that measures the user's “eclecticity”, that is how much they are prone to enjoying currently or historically popular people, places and things, versus preferring those that are in the long tail of diversity. The community and companionship of the user, that is the friends and followers they are near also is measured in the user pattern profile.

The purpose of the eclecticity measure is twofold. As mentioned, a user list of items can be composed of personally curated content items that are collated with curated content items from other associated users and lists from external content sources. Eclecticity determines the proportion of content to mix in from outside of the user's personally curated content. Likewise, it determines how similar the content mixed in should be to the user's typical content. For example, an eclectic user (i.e. a user with a high eclecticity score) in an eclectic location for themselves may receive 100% new content in their list (i.e. not content they have viewed before or curated themselves). This situation also corresponds to a new user starting the app for the first time. In other words, a new user will have a 100% eclecticity score until they interact with the system for a while allowing the system to identify patterns in their activity. In another example, an eclectic user in a familiar location will receive a mix of content that matches that user and location and new nearby content that may be unfamiliar to the user. In another example, a typical user (i.e. with a low eclecticity score) in an eclectic location will receive a mix of content that matches user and location and new nearby content that matches the user's preferences more closely. Similarly, a typical user in a familiar location will receive a list consisting mainly of previously identified content with any new content closely matching existing preferences. The typical/eclectic modelling scheme may be extended to support familiar places at eclectic times (e.g., workplace at night) and eclectic places at familiar times (a different restaurant every Friday night).

From a search perspective the eclecticity measure for a user defines how broad a search space to explore to form a list of items to return to the user, and also how similar the items in the space should be to previously identified items. Using an initial model which identifies popular media (movies in theaters, current TV shows bestsellers, etc.), people (Facebook connections, newsworthy individuals, celebrities) and locations (population density) new users receive a crafted set of initial data designed to quickly tease apart the users' level of eclecticity.

The system also identifies new content that is demoted by a user. These signals are used to help recognize content types that are less interesting to a user, (e.g. British restaurants, dive bars, skateboard parks) to constrain the search space for novel items to show users. The system recognizes that user patterns are such that there are situations where users enjoy previously demoted novel content, so does not eliminate anything out of hand. The system may promote contextually relevant items from its partner's fulfillment APIs to the users, which result in affiliate fees when the user chooses to fulfill them. The pattern engine and ranking engine enable the real time scoring of content to promote such items in context

### Example Process for Context-Aware Information Discovery

The following describes example processes for context-aware information discovery. According to embodiments, a system (e.g., system 100 described in FIG. 1) provides for continuous information flow between clients 102a-n and servers 106a-b, driven by environmental input from the user's actions and contextual information (GPS signal, sensor data such as temperature, device speed, orientation, etc.), as well as blended social context such as friends being together. The flow results in real time (or near real time) ranking and re-ranking of information lists containing curated and novel content items, and learning of user patterns, resulting in further user actions etc. (content, learning and ranking feedback loop). Content is merged into a unified list view supporting consistent interaction with both user curated content and system recommended new content (i.e content not curated by the user or previously presented to the user). A user interface with simple primitives, keep, demote, filter, curate, (sleep/wake) enables a complete interaction between the displayed lists and the ranking and user pattern learning engine. A ranking engine merges and ranks lists of existing user content with lists of content from related users, either explicitly connected as friends, followers or else connected because of profile overlap, as well as lists of new (heretofore unseen) content from external information sources, based on a user pattern profile. The user pattern enables the ranking engine to prioritize curated content or novel content, related user content or personal content, content based on type (book, movie, food, drink, event, place) by understanding where and when the user is and how that relates to their typical patterns.

The innovations described in this application provide for a continuous feedback loop of information from the client in the form of user actions and location and client sensor data that input into the system from the client (e.g. a client device 102a-n). This input is processed by the system, and allows the system to identify if the client needs more data or if the context of the client has changed enough that new data must should be presented to the client. In the first case the user has exhausted the data available on the client and the system computes the next data to be presented to the client. In the second case, the users has changed location or generated new content, time has passed, friends are nearby or they have generated new content, and these changes are such that the optimal next user activities would be ranked differently. The personally curated, related user and location/time sensitive content are ranked and collated based on the new context, and the newly ranked list is returned to the client.

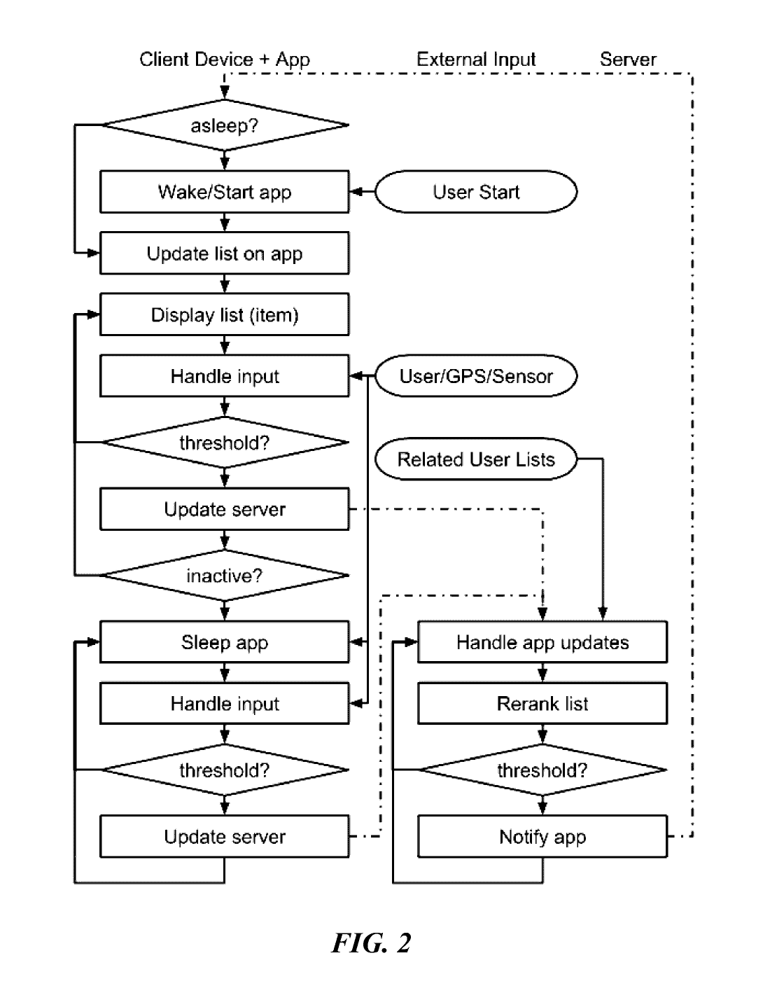

FIG. 2 is a flow chart describing an example process for providing context-aware information discovery. The process begins with activation of a client application (e.g. a mobile app or web app) by starting it, awaking it from the background either actively or in response to a notification from a server. In response, a server (e.g. servers 106a-b) associated with the system (e.g. system 100) provides an updated list of content to the client device using the latest contextual cues (e.g. sensor data from the client device). In the case where the user has never used the application before contextual cues are used to initialize the user's list of content with locally relevant items (e.g., movie listings, restaurant locations, sports, museums, performances, etc.) from which the user can make an initial selection of items. In some embodiments, items are selected with the goal of inducing user interaction to learn the user's preferences. For example, the system may recommend a local music performance by a popular artist to induce user interaction and learn about the musical preferences/patterns of the user. Based on user interaction with the recommended content (e.g. demoting, or keeping the content associated with the performance) the system can learn not only if the user likes the particular recommended artist, but can also measure the “eclecticity” of the user's musical tastes. The concept of “eclecticity” is described in more detail herein. Otherwise the system ranks and collates these locally relevant items with items already on the user's list as well as items on any of the related user's lists. The list of items is then presented to the user at the client device (e.g. via the client application) in a scrollable fashion, or as a stack of cards the user may swipe to dismiss or preserve.

User interaction with the application as well as contextual data received at the client device (e.g. location and sensor input such as temperature, speed and orientation) are constantly monitored by the application. This user interaction data and contextual data are processed locally and sent to the pattern learning engine server 106a if a change threshold is exceeded or the local data is insufficient to present additional content to the user.

If the user is active, the active application continues processing, otherwise, in some embodiments the application enters a sleep mode, but continues processing contextual data (e.g. location and sensor input) in the background. If a threshold level of changes occur in the contextual data, the application can transmit the data to the server. Meanwhile the server handles received data (e.g. interaction/contextual) from the client device, which can also include changes from other users to their lists, as well as context changes of the user's friends/followers. A ranking engine re-ranks the content list based on the accumulated context changes. If enough changes to the ranking occur so that a threshold is exceeded, (for example, one or more items that were not previously highly ranked are now among the top items in the list, or the app requested more list items having exhausted its local list) the server notifies the application of a refreshed list to load.

### User Interaction

The present disclosure also provides for a novel user interaction paradigms. According to some embodiments, user-curated lists of content items are ranked and collated with content items from external sources and content items from other associated users (e.g. based on social network connections) to form unified sets of user interaction primitives that provide for uniform content interaction management. This approach includes treating the provenance of the list items as metadata of those items, so that the list has uniform overall content. Use of metadata still allows for unique treatment of the underlying actual data if needed. The addition of metadata not only for provenance of the content, but also score adjustments, and contextual data means that user interaction with the content directly affects the way every viewed content item is subsequently ranked, and how new content items similar to those viewed will be included in subsequent rankings. The system is able to learn the user patterns from the metadata accumulated through using the application, and offer new content and rankings of content dynamically based on the feedback.

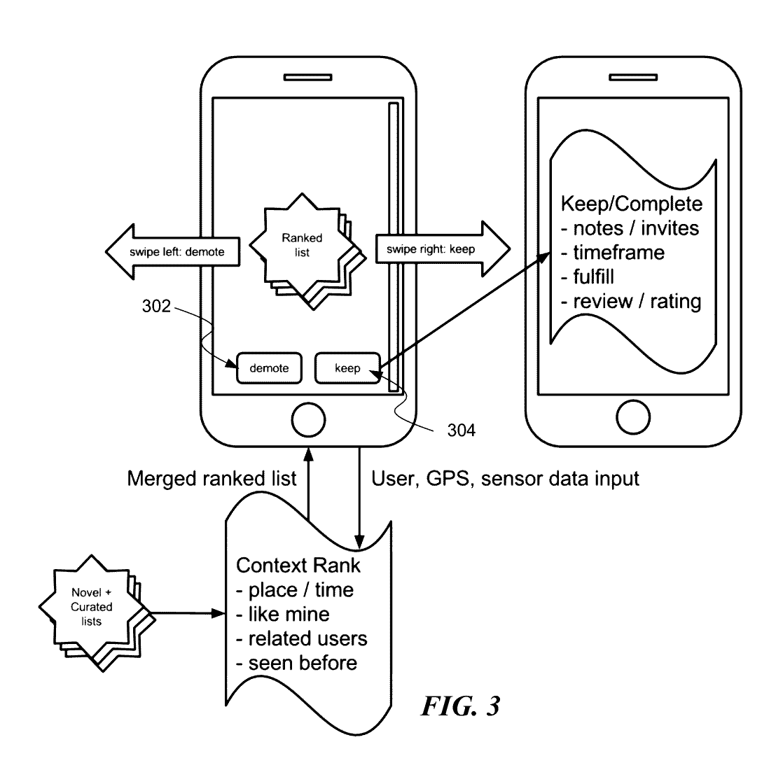

FIG. 3 shows example user interactions with an interface presented at a client device. As shown in FIG. 3, a ranked list of items is presented to the user via the user interface. This ranked list can be self-curated by the user, created by other users associated with the user, and/or system generated based on content available from external sources. A user interaction feature allows for input by the user to keep or demote content items in this list.

A keep action on a newly recommended content item results in the item being added to the user's personal list, presenting an option to fulfill the activity immediately. The same action on an item already in the user's list allows the user to fulfill the activity or mark the item as fulfilled and/or to add recommendations. Fulfilling the item presents an opportunity to direct the user to partner businesses to monetize the user activity through affiliate fees. The keep primitive 304 shown in FIG. 3 is supported for example by a right swipe on a touch sensitive display, or by clicked button for example on any client system. The keep primitive 304 offers the ability to add a new item from an external content source or from a related user's list onto the personal list associated with the user, to indicate completion and rate or recommend any item. In response to user interactions with the keep primitive 304, the system sets and raises the score of an item each time it is seen.

A demote action on an item lowers its score for the current user. A count of demotions is kept, and can be used to prevent the item from being presented to the user in the future (autofiltering) or to remove an item from the user's list based on the demote count. The demote primitive 302 is supported by a left swipe on a touch sensitive display, or by clicked button for example on any client system. The demote primitive 302 dismisses a content item from display, and lowers the score of the item.

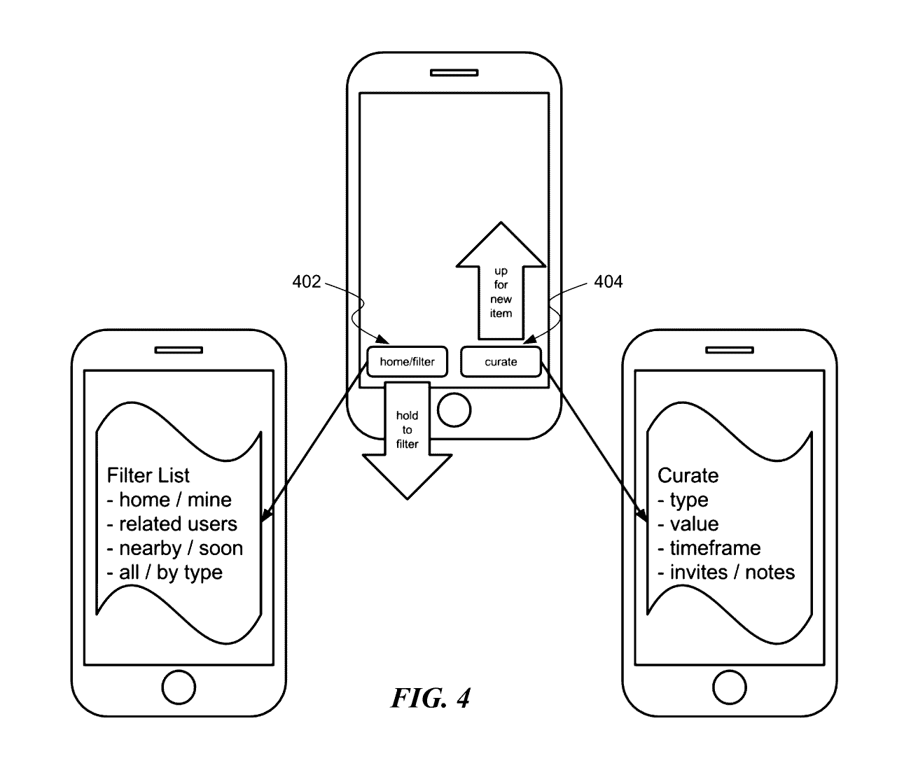

FIG. 4 shows example user interactions with an interface presented at a client device to filter presented content or curate/create new content. The filter 402 and curate 404 user action primitives allow a user to specify currently interesting subsets of content presented by the system, or to curate/create new content to be presented by the system.

The filter/refresh primitive 402 brings up a view which allows the user to restrict or expand the content viewed in the main list view, by type (e.g., book, movie, sports, concert, restaurant), by source (e.g., personally curated, social network curated, friend curated, system recommended), and by context (e.g., recently added, nearby, happening soon, active vs. sit down, completed). The filter/refresh primitive 402 may be supported by a press and hold, a hard press or a down swipe of the touch sensitive display or by clicked button for example on any client system. The filter/refresh primitive 402 allows the user to narrow down the list to their own content, to novel content, to recent content, to related users' content by selecting from a list brought up by the filter primitive. A novel aspect of the filter/refresh primitive 402 is that there is no distinction in the system between a user's profile and a user's feed (as there is in every social media system from Facebook™ to Google+™ to Instagram™ etc.) It is similar in presentation, and differs only in the filter setting.

The curate primitive 404 brings up a similar view which allows the user to manually add a newly discovered content item. The curate/new primitive 404 may be supported by a swipe up on a touch sensitive display, or by clicked button for example on any client system. The curate primitive lets the user create a new content item that is added to the user content list, shared with friends, followers, and subsequently ranked alongside all of the other content in the system. A novel aspect of the primitive 404 is that it assigns the initial metadata needed for ranking at creation time, which immediately makes the item rank-able throughout the system, even in other related users' lists.

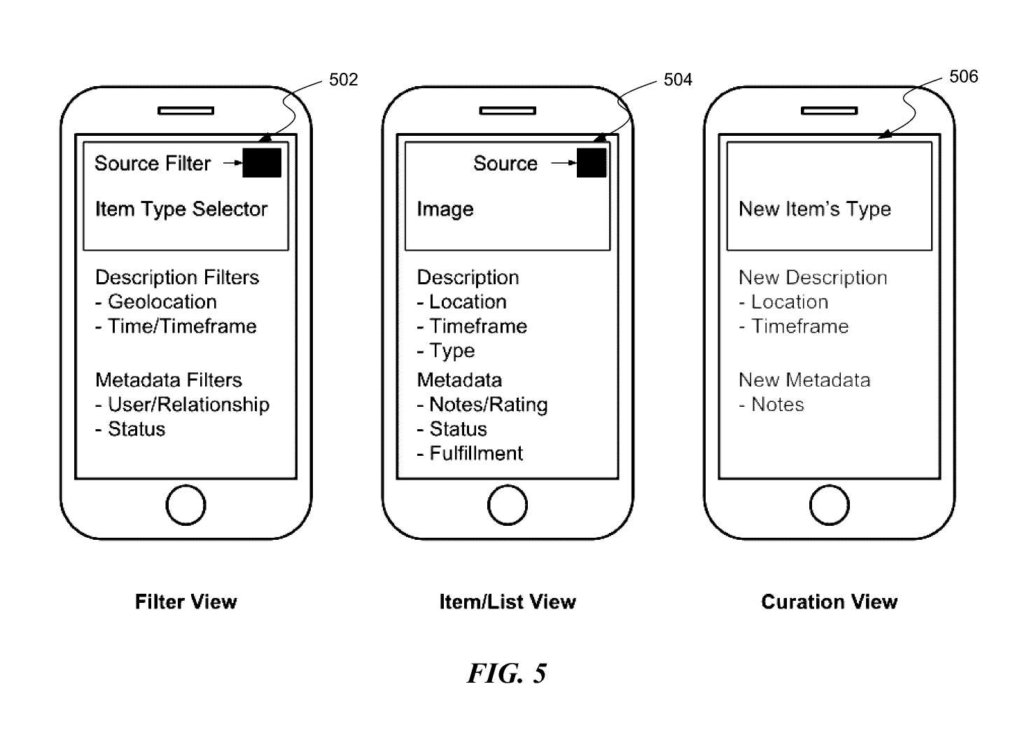

FIG. 5 shows example interface layouts for several representative views presented by the system, for example, a filter view 502, an item/list view 504, and a curation view 506. Visual source cues, for example in the form of a simple text box, icon or color code, may be used to distinguish personally curated content by the user from content curated by other users, or from system recommended content. Otherwise the views can be similar in appearance and interaction.

As shown in FIG. 5, a list view 504 presents an image or graphic associated with a content item, its source (e.g., self-created, influencer created, system created), a description, location, timeframe and any relevant user and system metadata such as completion status.

A filter view 502 allows the user to filter presented content items according to various criteria (e.g., type, source, location, timeframe, etc.) to restrict the list view to relevant matches. The filter view 502 visually expresses the different constraints that are imposable on the queries that are issued to the system. In particular, the null filter with no user supplied constraints generates the default unfiltered list view a user encounters when launching the application.

A new item or curation view 506 provides options for a user to fill in specifics of a new item to add that content item to the system. The user may start by choosing a type of activity and entering the first few letters of the activity to receive an autocompleted list of relevant activities to choose from. Importantly, metadata connected to the curated content, such as time and location of creation, the user's context, and any notes the user adds, enables the server system to improve the contextual ranking of the item.

Not shown in FIGS. 3-5 is a wake/sleep primitive that can place the application in a background mode (as opposed to an active mode). In background mode, user input and interactive display features are halted, while important system data such as GPS coordinate changes and sensor updates such as speed, orientation, temperature etc. are still collected for the purposes of updating user context within the system, which can update list rankings and cause the service to notify the user of those updated rankings.

### Example Computer System

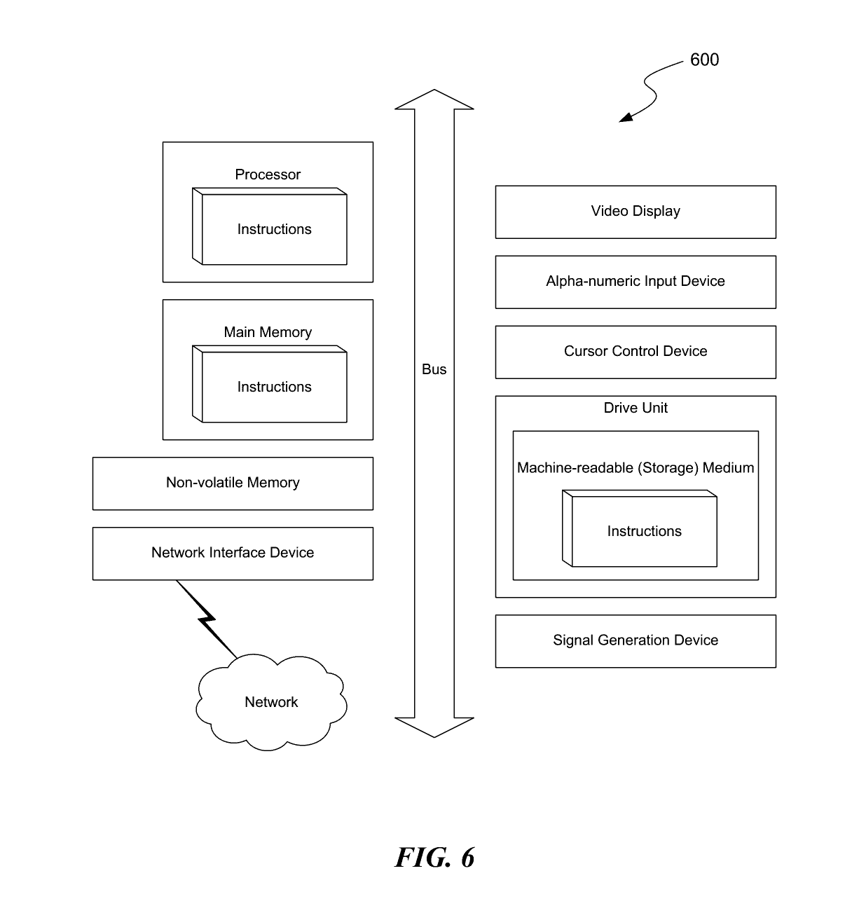

FIG. 6 is a diagram illustrating a machine 600 in the example form of a computer system within which a set of instructions, for causing the machine to perform any one or more of the methodologies discussed herein, can be executed.

In alternative embodiments, the machine operates as a standalone device or can be connected (e.g., networked) to other machines. In a networked deployment, the machine can operate in the capacity of a server or a client machine in a client-server network environment, or as a peer machine in a peer-to-peer (or distributed) network environment.

The machine may be a server computer, a client computer, a personal computer (PC), a user device, a tablet, a phablet, a laptop computer, a set-top box (STB), a personal digital assistant (PDA), a thin-client device, a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed repository, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 600 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

What is claimed is:

1. A method comprising the steps of:
receiving, by a computer system, user data collected at a client device associated with a user, the user data including user interaction data and contextual data;
generating, by a computer system, a user pattern profile based on the user data;
scoring, by the computer system, available content items based on the user pattern profile and the contextual data;
generating, by the computer system, a sorted list of content items from the available content items based on the scoring; and
presenting, by the computer system at the client device, the sorted list of content items.

2. The method of claim 1, wherein the user interaction data is associated with interactions by the user with the sorted list of content items presented at the client device.

3. The method of claim 2, wherein interactions by the user include demoting and/or keeping items in the sorted list presented at the client device

4. The method of claim 1, wherein the contextual data includes one or more of the following:
sensor data collected by sensors at the client device; or
location data collected at the client device.

5. The method of claim 1, further comprising:
presenting options at the client device to filter the sorted list of content items.

6. The method of claim 1, further comprising:
presenting options at the client device to create new content items to add to the sorted list.

7. The method of claim 1, wherein the available content items include one or more of the following:
content items curated by the user;
content items curated by other users associated with the user; or
content items available from external sources.

8. The method of claim 1, wherein the scoring is based at least in part on an eclecticity measures associated with the user, the eclecticity measure based on the user pattern profile.

9. The method of claim 8, wherein sorted list of content items includes user-curated content and external content, and wherein the proportions of user-curated content and external content included in the sorted list is based on the eclecticity measure associated with the user.

10. A method comprising the steps of:
receiving, by a computer system, user data collected at a client device associated with a user, the user data including contextual data;
identifying, by the computer system, a contextually relevant content item from a set of available content items based on the received contextual data;
presenting, by the computer system at the client device, the contextually relevant content item;
receiving, by the computer system a user interaction with the contextually relevant content item;
inferring, by the computer system, a user preference based on the user interaction; and
creating a new or updating an existing user pattern profile based on the inferred user preference.

11. The method of claim 10, wherein the available content items include one or more of the following:
content items curated by the user;
content items curated by other users associated with the user; or
content items available from external sources.

12. A computer system comprising:
a processor; and
a memory unit coupled to the processor, the memory unit including instructions stored thereon, which when executed by the processor, cause the computer system to:
receive user data collected at a client device associated with a user, the user data including user interaction data and contextual data;
generate a user pattern profile based on the user data;
score available content items based on the user pattern profile and the contextual data;
generate a sorted list of content items from the available content items based on the scoring; and
present, at the client device, the sorted list of content items.

13. The computer system of claim 12, wherein the user interaction data is associated with interactions by the user with the sorted list of content items presented at the client device.

14. The computer system of claim 13, wherein interactions by the user include demoting and/or keeping items in the sorted list presented at the client device

15. The computer system of claim 12, wherein the contextual data includes one or more of the following:
sensor data collected by sensors at the client device; or
location data collected at the client device.

16. The computer system of claim 12, wherein the memory unit includes further instructions stored thereon, which when executed by the processor, cause the computer system to further:
present options at the client device to filter the sorted list of content items.

17. The computer system of claim 12, wherein the memory unit includes further instructions stored thereon, which when executed by the processor, cause the computer system to further:
present options at the client device to create new content items to add to the sorted list.

18. The computer system of claim 12, wherein the available content items include one or more of the following:
content items curated by the user;
content items curated by other users associated with the user; or
content items available from external sources.

19. The computer system of claim 12, wherein the scoring is based at least in part on an eclecticity measures associated with the user, the eclecticity measure based on the user pattern profile.

20. The computer system of claim 19, wherein sorted list of content items includes user-curated content and external content, and wherein the proportions of user-curated content and external content included in the sorted list is based on the eclecticity measure associated with the user.
